(19) United States
(12) Patent Application Publication
(10) Pub. No.: US 2019/0268723 A1
(43) Pub. Date: Aug. 29, 2019

(54) SYSTEM FOR NOTIFICATION OF ENTRY OF A BOUNDARY

(71) Applicant: Mark Arthur Hall, Cocoa, FL (US)

(72) Inventor: Mark Arthur Hall, Cocoa, FL (US)

(21) Appl. No.: 16/184,062

(22) Filed: Nov. 8, 2018

Related U.S. Application Data
(60) Provisional application No. 62/634,450, filed on Feb. 23, 2018.

(51) Int. Cl. H04W 4/029; H04W 4/021; H04W 68/00

(52) U.S. Cl. CPC H04W 4/029; H04W 68/005; H04W 4/021

(57) ABSTRACT

A system for notification of entry of a boundary including a database that stores data. The data includes a plurality of boundaries each surrounding a different geographic region. A mobile device includes a processor, a memory, a user interface, a communications interface, a geolocator, and a notification module. The processor of the mobile device receives the data from the database via the communications interface, determines if the mobile device is within one of the plurality of boundaries via the geolocator, and activates the notification module if the mobile device is within one of the plurality of boundaries.

### CROSS-REFERENCE TO RELATED APPLICATION

This application claims the benefit of priority of U.S. provisional application No. 62/634,450, filed Feb. 23, 2018, the contents of which are herein incorporated by reference.

### BACKGROUND OF THE INVENTION

The present invention relates to boundary notification and awareness and, more particularly, to a system for notification of entry of a boundary.

Certain individuals are not permitted to enter certain locations. For example, hunters may accidentally travel onto land in which they are not permitted to be on. Additionally, sex offenders are not permitted by law to enter a zone that is within a distance of a school, daycare, or the like. Determining where the user may or may not be permitted to enter can be difficult. Without knowing the exact location and distance, the individuals may unknowingly enter the unpermitted location.

As can be seen, there is a need for a system for notification of entry of a boundary.

### SUMMARY OF THE INVENTION

In one aspect of the present invention, a system for notification of entry of a boundary comprises: a database storing data, wherein the data comprises a plurality of boundaries each surrounding a different geographic region; a mobile device comprising: a processor; a memory; a user interface; a communications interface; a geolocator; and a notification module, wherein the processor receives the data from the database via the communications interface; determines if the mobile device is within one of the plurality of boundaries via the geolocator; and activates the notification module if the mobile device is within one of the plurality of boundaries.

These and other features, aspects and advantages of the present invention will become better understood with reference to the following drawings, description and claims.

### BRIEF DESCRIPTION OF THE DRAWINGS

FIG. 1 is a flowchart of an embodiment of the present invention; and

FIG. 2 is a front view of a mobile device implementing an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

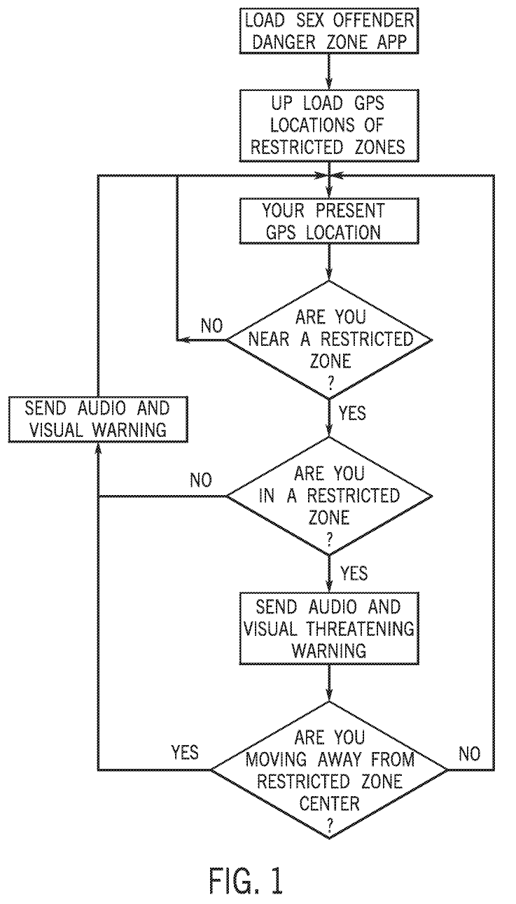

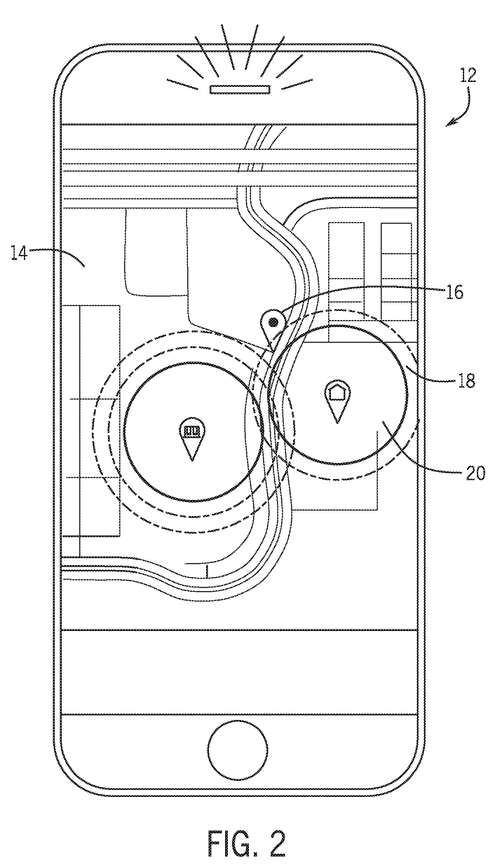

Referring to FIGS. 1 and 2, the present invention includes a system for notification of entry of a boundary 18, 20. The present invention includes a database that stores data. The data includes a plurality of boundaries 18, 20 each surrounding a different geographic region. The geographic locations may be identified via geolocation data, such as latitudinal and longitudinal data. The present invention further includes a mobile device 12. The mobile device 12 includes a processor, a memory, a user interface, a communications interface, a geolocator, and a notification module. The processor of the mobile device 12 receives the data from the database via the communications interface, determines if the mobile device 12 is within one of the plurality of boundaries 18, 20 via the geolocator, and activates the notification module if the mobile device 12 is within one of the plurality of boundaries 18, 20.

The mobile device 12 of the present invention may be a mobile smart phone, a tablet, or other smart portable device with a computing system. The computing system is at least the processor and the memory. The computing system may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing system includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for user communication with the computing system. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these. The notification module may be part of the user interface. For example, the notification module may include a speaker, a vibration device, a touchscreen, lights and the like. When the notification module is the speaker, the notification is a sound produced by the speaker. When the notification module is the touchscreen, the notification is a message displayed on the touchscreen. When the notification module is the vibration device, the notification is a vibration. Further, the notification module may be a combination of the above-mentioned user interfaces and may thereby produce a combination of notifications.

The communication interface includes hardware, software, or both providing one or more interfaces for communication (e.g., packet-based communication) between the computing system and one or more other computing systems or one or more networks. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing system may include any suitable communication interface for any of these networks, where appropriate.

The geolocator of the mobile device 12 may be any device and communication component that determines a geolocation of the mobile device 12. For example, the geolocator may be a global positioning system of the mobile device 12. The distance between cellular towers may also be used to determine a geolocation.

As illustrated in FIG. 2, the mobile device 12 may display a map 14 of an area. The area may be where the mobile device 12 is located as well as the surroundings of the mobile device 12. The map 14 may show a location of the mobile device 16 and boundaries 18, 20 that are located within the area.

The boundaries 18, 20 surrounding the geographic region may be stationary. For example, schools, daycares and the like may be disposed within the geographic region and therefore within the boundaries 18, 20. In such embodiments, the boundaries 18, 20 are stationary and the mobile device 12 is mobile. Further, acreage of property is stationary. Therefore, the notification module is only activated within the mobile device 12 moves into one of the plurality of boundaries 18, 20.

In certain embodiments, each of the plurality of boundaries 18, 20 include an outer caution zone 18 and an inner restricted zone 20. In such embodiments, the processor activates a first notification via the notification module if the mobile device 12 is within the outer caution zone 18 of one of the plurality of boundaries 18, 20, and activates a second notification via the notification module if the mobile device 12 is within the inner restricted zone 20 of one of the plurality of boundaries 18, 20. This feature provides a warning to the user that they are approaching a restricted area before entering the restricted area. The first notification is different from the second notification. For example, the first notification may be a sound played from the speaker including a warning message and the second notification may be a sound played from the speaker including a leave now message. As illustrated in FIG. 1, if the mobile device 12 remains within either the inner restricted zone 20 or the outer caution zone 18, the mobile device determines the location again and activates the notification module until the mobile device 12 is outside of the respective boundary 18, 20.

It should be understood, of course, that the foregoing relates to exemplary embodiments of the invention and that modifications may be made without departing from the spirit and scope of the invention as set forth in the following claims.

What is claimed is:

1. A system for notification of entry of a boundary comprising:
a database storing data, wherein the data comprises a plurality of boundaries each surrounding a different geographic region;
a mobile device comprising:
a processor;
a memory;
a user interface;
a communications interface;
a geolocator; and
a notification module, wherein the processor
receives the data from the database via the communications interface;
determines if the mobile device is within one of the plurality of boundaries via the geolocator; and
activates the notification module if the mobile device is within one of the plurality of boundaries.

2. The system of claim 1, wherein the user interface is a touchscreen interface.

3. The system of claim 2, wherein the notification module comprises at least one of a speaker and the touchscreen, wherein the notification is at least one of a sound produced by the speaker and a message displayed on the touchscreen.

4. The system of claim 2, wherein the processor
displays a map of an area on the touchscreen, wherein the map shows a location of the mobile device, and boundaries of the plurality of boundaries located in the area.

5. The system of claim 1, wherein the communication interface communicates over a telecommunications network.

6. The system of claim 5, wherein the processor downloads the data over the telecommunications network and saves the data on the memory.

7. The system of claim 1, wherein each of the plurality of boundaries comprises an outer caution zone and an inner restricted zone.

8. The system of claim 7, wherein the processor
activates a first notification via the notification module if the mobile device is within the outer caution zone of one of the plurality of boundaries, and
activates a second notification via the notification module if the mobile device is within the inner restricted zone of one of the plurality of boundaries, wherein
the first notification is different from the second notification.

9. The system of claim 1, wherein the plurality of boundaries surrounding the geographic region are stationary.

10. The system of claim 1, wherein the geolocator and a global positioning system.
